(19) United States
(12) Patent Application Publication
(10) Pub. No.: US 2002/0064338 A1
(43) Pub. Date: May 30, 2002

(54) Hermetic sealing of optical fiber in wall of IOC package

(76) Inventors: Henry H. Hung, Phoenix, AZ (US); Yellapu Anjan, Scottsdale, AZ (US)

Correspondence Address: TOD R. NISSLE, P.C., P.O. Box 55630, Phoenix, AZ, 85078, US

(21) Appl. No.: 09/726,916

(22) Filed: Nov. 30, 2000

(51) Int. Cl. G02B 6/26

(52) U.S. Cl. 385/22

(57) ABSTRACT

A method and apparatus for sealing an optical fiber in a housing includes welding the optical fiber to fused silica or to a glass frit material such that the physical properties of the optical fiber are substantially unchanged.

This invention relates to the packaging of an optical circuit.

More particularly, the invention relates to the installation of an optical fiber during packaging of an optical circuit.

An integrated optic chip (IOC) is made of an electro-optic material whose index of refraction increases or decreases depending on the direction of electric field applied to it. IOC's are analogous to integrated circuits (IC's) utilized in semiconductor technology. The signal processing in an IC is totally electric whereas in an IOC it is both optical and electrical. The term “integrated” in “integrated optic chip” implies that the chip has both electrical and optical parts. One or more external electrical signal(s) is applied to one or more electrodes formed on an IOC and the electrical signals change the index of refraction of one or more waveguides adjacent to the electrodes. Changing the index of refraction of a waveguide produces a concomitant change in the intensity and/or phase of light passing through the waveguide. An IOC device is a device which includes one or more IOCs.

An integrated optic device (IOD) is one of a class of devices for guiding and controlling light in thin film layers or in narrow waveguide channels fromed in a suitable material, which suitable material norally comprises a dielectric. The IOD can comprise either a single type including transducers, filters, modulators, memory elements, and others or of several function applications (IOCs) combined (“integrated”) into a single device.

An optical circuit is a circuit which includes one or more IOCs, one or more IODs, or which transmits light through a solid material that comprises part of the circuit.

During the installation of a modulator or other optical circuit in a protective housing, an optical fiber is directed through an aperture in the wall of the housing and is connected to the modulator. To compensate for the refractive indices of light in the optical fiber and in the modulator, the optical fiber must be connected to the modulator at an angle to the longitudinal axis of the modulator. This angle can vary, but is presently about five degrees. When the optical fiber comes through the wall of the protective housing, it is parallel to the longitudinal axis of the modulator. Consequently, in order to connect the optical fiber to the modulator, the fiber is slightly bent. This procedure is acceptable during traditional manual process for attaching the fiber to the modulator. However, automated tooling heads used to attach the optical fiber to the modulator do not readily handle a slight curved fiber, especially in the limited space available in the protective housing.

Another problem encountered in installing an optical fiber involves passage of the fiber through an aperture in the wall of the protective housing. A hollow feedthrough tube is soldered in the aperture. A center portion of the fiber is gold plated and soldered inside a stainless steel protective sleeve. The fiber is then passed through the aperture such that the stainless steel protective sleeve is positioned in the hollow feedthrough tube. One end of the fiber is pigtailed or otherwise connected to the modulator. The protective sleeve is then soldered to the feedthrough tube. Coating the fiber with gold and soldering the fiber into the stainless steel protective sleeve makes the fiber extremely fragile and susceptible to breaking at the solder joint.

Accordingly, it would be highly desirable to provide an improved optical circuit packaging method and apparatus which would facilitate automated pigtailing and would reduce the risk of breakage of an optical fiber soldered in place during packaging of an optical circuit.

Therefore, it is a principal object of the invention to provide an improved method and apparatus for packaging an optical circuit.

Another object of the invention is to provide an improved method and apparatus for automating the pigtailing of an optical fiber to a modulator or other optical circuit.

A further object of the invention is to provide an improved method and apparatus for soldering an optical fiber in the wall of a housing for an optical circuit.

These and other, further and more specific objects and advantages of the invention will be apparent to those of skill in the art from the following detailed description thereof, taken in conjunction with the drawings, in which:

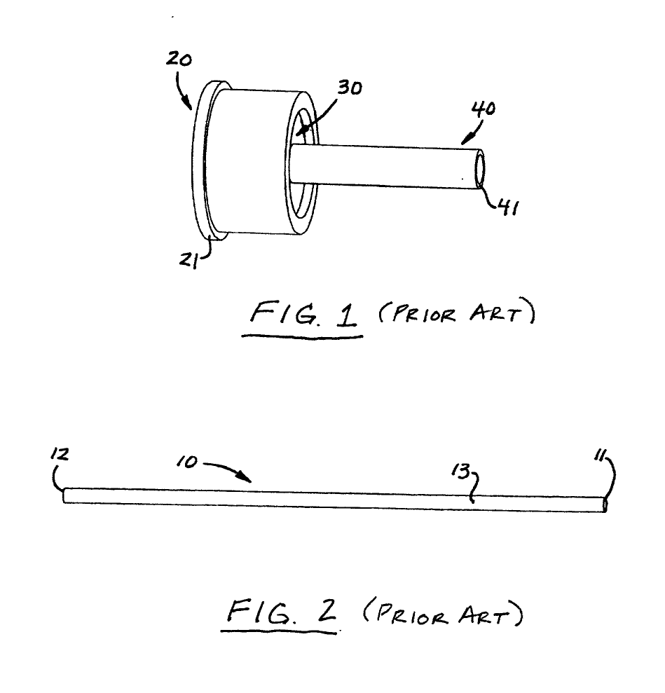

FIG. 1 is a perspective view illustrating a component utilized to form a hermetic seal in accordance with the prior art;

FIG. 2 is a perspective view illustrating another component utilized to form a hermetic seal in accordance with the prior art;

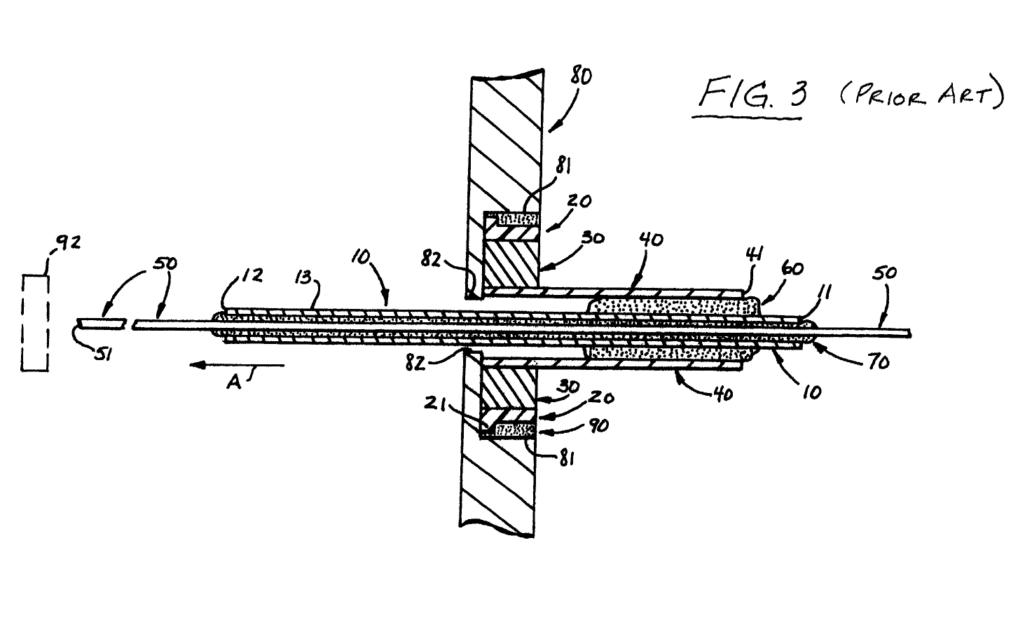

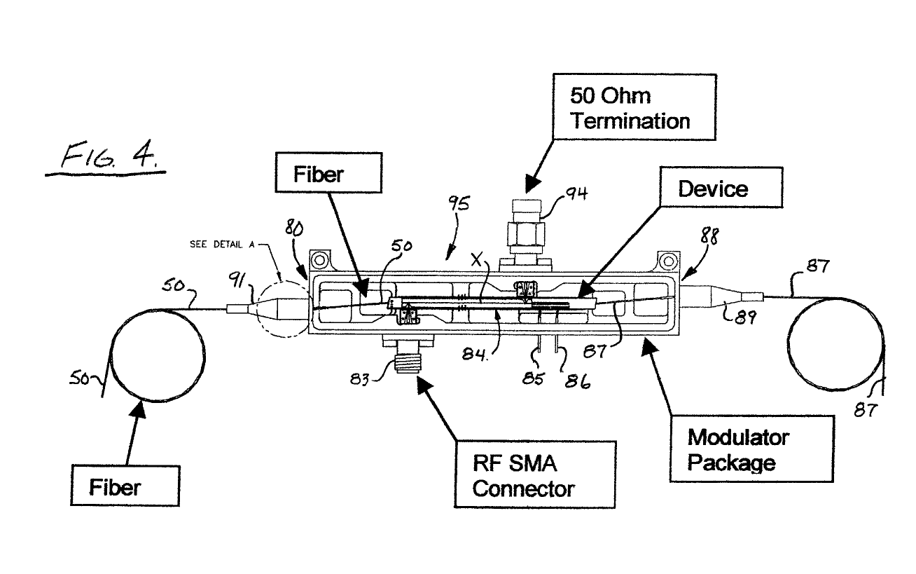

FIG. 3 is a section view illustrating a hermetic seal formed in a housing for an optical circuit in accordance with the prior art;

FIG. 4 is a top view illustrating the installation of optical fibers in the housing for an optical circuit in accordance with another prior art procedure;

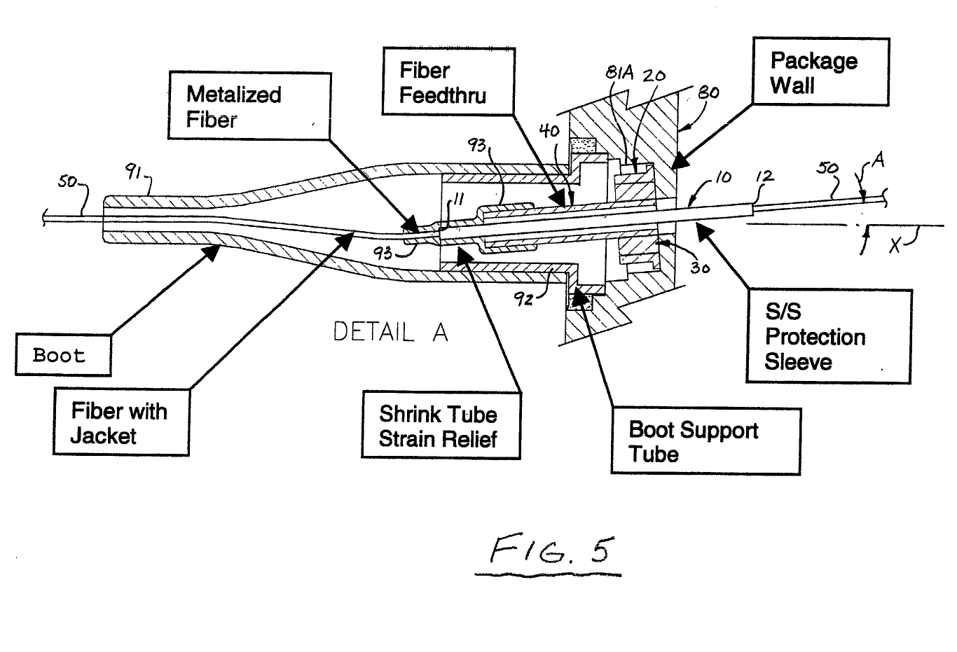

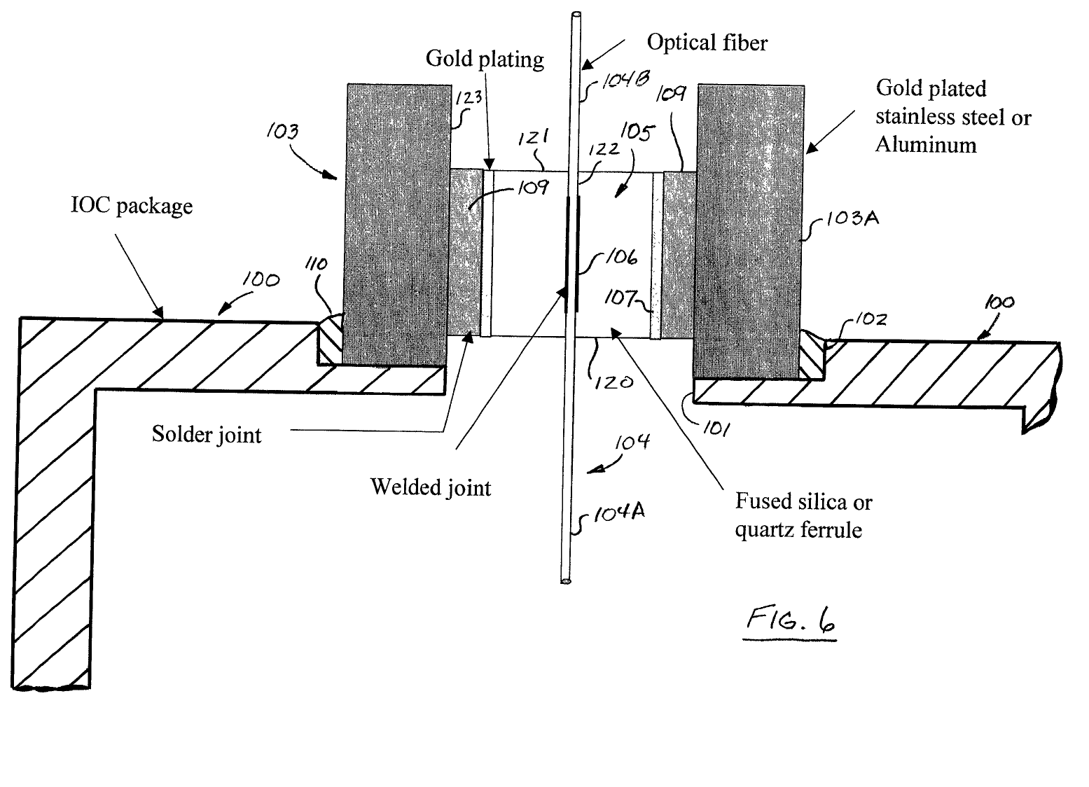

FIG. 5 is a side section view illustrating further construction details of the installation of an input fiber in a wall of the housing of FIG. 4;

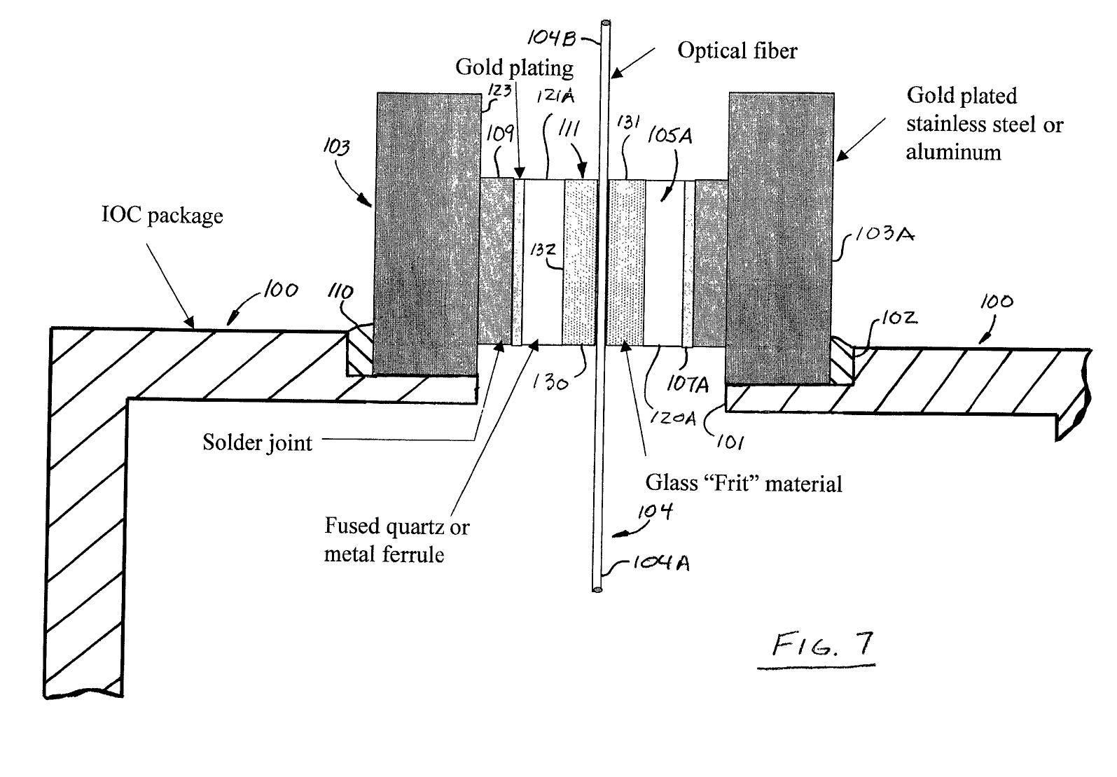

FIG. 6 is a side section view illustrating the installation of an optical fiber in a housing for an optical circuit in accordance with the principles of the invention; and,

FIG. 7 is a side section view illustrating the installation of an optical fiber in a housing for an optical circuit in accordance with another embodiment of the invention.

Briefly, in accordance with the invention, I provide an improved method for installing an optical fiber in an aperture formed through the wall of a housing for an optical circuit. The optical fiber has a selected coefficient of thermal expansion and melting point. The method includes the step of positioning a portion of the optical fiber in a mounting member. The mounting member has a first end and a second end. The optical fiber extends outwardly from the first and second ends. The mounting member has a melting point and coefficient of thermal expansion equivalent to that of the optical fiber. The method also includes the steps of fusing the mounting member to the optical fiber; and, installing the mounting member in the aperture.

In another embodiment of the invention, I provide an improved assembly for installation in an aperture formed through the wall of a housing for an optical circuit. The assembly includes an optical fiber having a selected coefficient of thermal expansion and melting point; and, a mounting member fused to said optical fiber and having a melting point and coefficient of thermal expansion equivalent to that of the optical fiber.

In a further embodiment of the invention, I provide an improved method for preparing an assembly for installation in an aperture formed through the wall of a housing for an optical circuit. The method includes the steps of applying a paste to an optical fiber; and, heating the paste to bond the paste to the optical fiber and fused silica ferrule or tube.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 to 3 illustrate one prior art apparatus for installing an optical fiber in the wall of a housing for an optical circuit.

FIG. 1 illustrates a hollow cylindrical metal component 20, hollow ceramic component 40, and a cylindrical insulative glass seal 30 extending between and separating components 20 and 40. Seal 30 functions as an insulator and prevents or slows the transfer of heat from component 40 to component 20. The spanning of seal 30 intermediate components 20 and 40 is also depicted in FIG. 3. Component 20 includes outwardly depending circular lip 21. Component 40 includes end 41. Component 40 can be fabricated from metal or another material, but ceramic is preferred because it does not readily conduct heat.

FIG. 2 illustrates hollow cylindrical metal stainless steel component 10. The outer cylindrical surface 13 and inner cylindrical surface of component 10 are presently preferably covered by a gold coating. Component 10 includes ends 11 and 12. The shape and dimension of and materials used to construct components 10 and 20 and the other components discussed below can vary as desired.

FIG. 3 illustrates a structural component comprising a wall 80. Wall 80 forms one side of the housing of an IOD or other optical circuit. During the following explanation of the assembly of the hermetic seal depicted in FIG. 3, it is assumed that the IOD housing comprises a hollow rectangular box, the top or lid of which has been removed. As would be appreciated by those of skill in the art, however, the shape and dimension of the IOD housing can vary as desired.

At least one IOC is in the hollow rectangular box. Optical fiber 50 must be connected to the IOC and must be hermetically sealed in wall 80. At some time subsequent to the connection of fiber 50 to the IOC and subsequent to the hermetic sealing of fiber 50 in wall 80, the lid of the housing is sealingly affixed to the hollow rectangular box to complete the hermetic sealing of the IOC in the box.

In order to produce the hermetic seal assembly illustrated in FIG. 3, cylindrical openings 81 and 82 are formed in wall 80. An end of component 40 is centered or otherwise positioned inside hollow cylindrical component 20, and insulative glass seal 30 is formed to fix the end of component 40 inside component 20 in the manner illustrated in FIG. 1. Component 20 is then seated in cylindrical opening 81 in the position shown in FIG. 3 and indium solder 90 is heated to 250 degrees C and inserted intermediate opening 81 and the outer cylindrical surface of member 20 in the manner illustrated in FIG. 3. Solder 90 is permitted to harden.

Metallized optical fiber 50 (for example, an optical fiber coated with the metal gold) is slid through component 10 to the position illustrated in FIG. 3 and indium solder 70 is heated to 250 degrees C and applied near ends 11 and 12 of component 10. Surface tension and capillary action cause the liquid solder 70 to wick or travel into component 10 intermediate fiber 50 and the inner cylindrical gold-plated surface of component 10. This wicking action may not completely fill the space between fiber 50 and the inside of component 10 in the manner shown in FIG. 3, but at least some of the solder 70 does wick inside component 10. The solder 70 is allowed to cool and harden to affix fiber 50 inside component 10.

After the solder 70 has cooled, component 10 (along with fiber 50 and solder 70 extending through component 10) is inserted through component 40 to the approximate position illustrated in FIG. 3. While any means or apparatus can be utilized to accomplish the positioning of component 10 in component 40, a vacuum chuck can be utilized to grasp and hold the end of fiber 50 extending out the right hand end (or left hand end) of component 10 in FIG. 3. The position of the vacuum chuck is adjustable up or down, left or right, front and back, etc. so that the position of fiber 50 and component 10 inside member 40 can be adjusted. This is important because when fiber 50 is in the position illustrated in FIG. 3 and is extending through member 40 and opening 82, the position of fiber 50 (and component 10) must be adjustable so that fiber 50 can be positioned with the vacuum chuck accurately to be connected to the IOC 92 which is inside the IOD housing of which wall 80 comprises a side. Once fiber 50 has been adjusted to its desired position and end 51 of fiber 50 has been connected to the IOC 92 which is inside the IOD housing, then indium solder 60 is heated to about 120 degrees C and is deposited at end 41 of component 40. Some of the solder 60 wicks inside component 40 in the manner illustrated in FIG. 3. If desired, solder 60 can also be deposited in opening 82 to further secure component 10 in wall 80. After solder 60 cools and solidifies, a hermetic seal has been formed between fiber 50 and opening 81.

Any desired solder can be utilized in the practice of the invention. To insure that the solder 60, 70, 90 forms a good hermetic seal, it is presently preferred that a metal solder be utilized.

FIGS. 4 and 5 illustrate an optical circuit packaged in accordance with another prior art process. As can be seen in FIG. 3, in many conventional optical circuit packages, component 20 is seated in cylindrical opening 81 such that the centerlines of opening 81, of cylindrical sleeve component 10, of cylindrical component 40, and of fiber 50 are each parallel to the longitudinal axis X of a modulator 84 mounted in the base 95 of a housing which includes wall 80. As earlier described, this means that the portion of fiber 50 inside housing must be bent in order to pigtail or attached the end of fiber 50 to the modulator. In contrast, in the process illustrated in FIGS. 4 and 5, opening 81A is formed in wall 80 such that when component 20 is seated in opening 81A, the centerlines of component 20, of component 40, of component 10, and of the portion of fiber 50 passing through aperture 81A are each canted at an angle A (FIG. 5) with respect to the longitudinal axis X of modulator 84 mounted in the base 95. Longitudinal axis X is parallel to the longitudinal axis of the portion of a light guide in modulator 84 which is at the left hand end of modulator 84. Fiber 50 is pigtailed to the left hand end of modulator 84 so that light from fiber 50 enters said light guide. The value of angle A is selected to compensate for the difference in refractive index between fiber 50 and the light guide in modulator 84 which receives light from fiber 50. Angle A is presently about five degrees.

FIG. 5 illustrates cylindrical boot support tube 92 and boot 91 which fits over tube 92 to protect fiber 50.

Fiber 50 is soldered in component 10 in the manner earlier described. This soldering makes the portion of fiber 50 which is adjacent end 11 of component 10 especially brittle and susceptible to breakage. In order to strengthen this fiber 50—component 10 junction, a polymer material 93 is placed around the junction and heat is applied. The polymer material 93 is manufactured such that the heat causes the polymer material to “shrink” and to conform to the fiber 50—component 10—component 40 junction in the manner illustrated in FIG. 5. Polymer material 93 is commonly known as “shrink wrap”. Material 93 functions to transfer to components 10 and 40 at least some of the stress and strain acting on fiber 50 at the fiber 50—component 10 junction. Even though material 93 conforms to fiber 50 and components 10 and 40 in the manner illustrated in FIG. 5, material 93 is preferably still somewhat elastic. Material 93 can, if desired, be substantially rigid after heat is applied and material 93 shrinks to conform to fiber 50 and members 10 and 40 in the manner illustrated in FIG. 5. The length of material 93 is presently about 0.375 inch. The shape and dimension of material 93 can vary as desired.

FIG. 6 illustrates a method and apparatus for installing in accordance with the invention an optical fiber 104 in an aperture 101 formed through the wall of a housing 100 for an optical circuit. The optical fiber 104 has a selected coefficient of thermal expansion and melting point. Fiber 104 typically is made of glass (SiO2) having a 99%+ purity and a hardness about equal to that of quartz.

The coefficient of thermal expansion are the ratios of the increase in length (linear coefficient), area (superficial coefficient), or volume (cubical coefficient) of a body for a given rise in temperature (usually from 0 degrees to one degree C) to the original length, area, or volume, respectively. These three coefficients are approximately in the ratio of 1:2:3. When not expressly specified, the cubical coefficient is usually intended. The linear coefficient of thermal expansion is presently of greatest interest in the practice of the invention.

Mounting member 105 has a first end 120 and a second end 121. The mounting member 105 preferably has a coefficient of thermal expansion and melting point which are equivalent or similar to those of the optical fiber 104. The coefficient of thermal expansion of member 105 is within 10%, preferably within 5%, most preferably within 1%, of the coefficient of thermal expansion of fiber 104. Similarly, the melting point of member 105 is within 10%, preferably within 5%, most preferably within 1%, of the coefficient of the melting point of fiber 104.

While member 105 can be fabricated from any desired material, member 105 is presently fabricated from glass, fused silica, or quartz. Silica occurs naturally in the three crystalline modifications of quartz, tridymite, and cristobalite, in amorphouse and hydrated forms (as opal), and is less pure forms (as sand, diatomite, tripoli). Glass is an amorphous inorganic usually transparent or translucent substance consisting typically of a mixture of silicates or sometimes borates or phosphates formed by fusion of sand or some other form of silica or by fusion of oxides of boron or phosphorus with a fux (as soda, potash) and a stabilizer (as lime, alumina). Member 105 is preferably comprised of a non-crystalline amorphous glass. One particular glass which can be utilized in the practice of the invention is VYCOR™, made by Corning. VYCOR is preferred because is has a lower melting point than fiber 104 and typically has a linear coefficient of expansion that is identical or nearly identical to that of fiber 104. It is preferred that member 105 have a melting point which is identical to or less than that of fiber 104 because this minimizes the likelihood that the properties of fiber 104 will be degraded when member 105 is melted at the fiber 104—member 105 interface to bond or fuse member 105 to fiber 104. The likelihood that the properties of fiber 104 will be degraded is especially reduced when the melting point of member 105 is less than that of fiber 104.

Hollow cylindrical sleeve 103 can be fabricated from any desired material but presently comprises metal, in particular stainless steel or aluminum. The cylindrical outer surface 103A and inner cylindrical surface 123 of sleeve 103 are plated with gold. Solder 110 secures the bottom of sleeve 103 in aperture 102.

Mounting member 105 includes outer end 121 and inner end 120. Cylindrical aperture 122 is formed through member 105 and is shaped and dimensioned to permit fiber 104 to slide through aperture 122.

Prior to soldering member 105 in sleeve 103, fiber 104 is slid into aperture 122 such that desired lengths or ends 104A, 104B of fiber extend outwardly from ends 120 and 121, respectively. Adjacent portions of member 105 and fiber 104 are melted and fused together using a CO2 laser, an oxygen/hydrogen torch, or an electron beam. The melting temperature of the material comprising member 104 and member 105 can vary but is typically about 1600 degrees C. Fiber 104 ordinarily is fabricated from a hard and pure glass having a composition of SiO₂.

When portions of member 105 and fiber 104 are so melted, a fusion zone 106 is produced which seals fiber 104 to member 105. When the linear thermal expansion coefficients and the melting temperatures of member 105 and fiber 104 are equivalent, the fusion of portions of member 105 and fiber 104 produces minimal, if any, additional structural stresses in the fusion zone 106 or adjacent the fusion zone.

After fiber 104 is inserted in and welded to member 105, member 105—along with fiber 104 affixed therein—is loosely positioned inside sleeve 103 and end 104A is pigtailed (attached) to the modulator 95 or other optical circuit in housing 100. End 104A extends through aperture 101 formed in the wall of housing 100.

Solder 109 is then utilized to secure member 105 to surface 123 of sleeve 103. Solder 109 is preferably 70% to 80% by weight indium and has a melting point in the range of 150 to 160 degrees C. The composition of the solder can vary as desired.

FIG. 7 illustrates an alternate method and apparatus for installing in accordance with the invention an optical fiber 104 in an aperture 101 formed through the wall of a housing 100 for an optical circuit. The optical fiber 104 has a selected coefficient of thermal expansion and melting point.

The method and apparatus of FIG. 7 are identical to those of FIG. 6 except that a cylindrical aperture 132 is formed through a member 105A. Member 105A can be fabricated from any desired material, but is presently fabricated from glass, fused silica, fused quartz or stainless steel.

Mounting member 105A includes outer end 121A and inner end 120A. Glass “frit” material 131 is applied to member 105A and fiber 104 with the procedure described below.

Prior to soldering mounting member 105A in sleeve 103, fiber 104 and a coating of glass “frit” material are of thicknesses from 25 to 50 microns slid into aperture 122 such that desired lengths or ends 104A, 104B of fiber extend outwardly from ends 120A and 121A, respectively. The glass frit material is a paste which includes microglass beads in a binder. The binder includes a solvent. The solvent evaporates when the paste dries to form a solid. While glass frit is available from a variety of commercial sources, the product presently utilized is PK-1015 manufactured by Vitta of 7 Trowbridge Drive, Bethel, Conn. 06801. PK-1015 is a paste mixture of glass fit or powder and a binder. The binder includes a solvent. The glass frit is made from borosilicate glass. Another sources of glass frit is KIA, Inc. of 25035 Detroit Road, #333, Westlake, Ohio 44145.

A thin layer 111 (25 to 50 microns in thickness) of frit is applied to fiber 104. The frit 111 is a paste. Frit 111 and fiber 104 are inserted in aperture 132 of member 105A in the manner shown in FIG. 7. The paste 111 is dried for 15 to 20 minutes at 75 degrees C to evaporate the solvent. Member 105A, the glass frit, and fiber 104 are then heated to a temperature in the range of 900-950 degrees C for 60 to 90 minutes in air or inert gas to melt, harden, and cure the glass frit. If desired, prior to heating the frit to 900 to 950 degrees C, holding the frit at 350 degrees C for 10 to 15 minutes burns off some or most of the binder before raising the temperature to 900-950 degrees C to cure the frit. Heating the frit to 900-950 degrees C is believed to melt the frit and allow it to bond to fiber 104. After the frit cools and hardens it sealingly bonds to fiber 104. While the linear thermal expansion coefficient of the melted and cooled frit can vary as desired, it is preferably intermediate the linear thermal expansion coefficient of fiber 104 and of member 105A. The cooled, hardened frit is believed to have some elasticity and to be able to adapt to the thermal expansion of both the fiber 104 and member 105A without separating from fiber 104 or member 105A. By way of example, the linear coefficient of thermal expansion of glass fiber 104 typically is about 0.5×10⁻⁶ per degree C, while the linear coefficient of thermal expansion of stainless steel is about 15 to 20×10⁻⁶ per degree C. The cooled hardened frit is preferably amorphous, and not crystalline although a crystalline frit structure may function to hermetically seal fiber 104.

When the frit paste 111 is being heated at 900-950 degrees C, a vacuum is preferably applied to either side of paste 111 to draw away air and any gases produced by evaporating solvent, etc. during curing of the frit 111. The strength of the vacuum can vary as desired but it presently produces a pressure equal to about one-third of atmospheric pressure.

After frit 111 is cured and hardened, member 105A—along with frit 111 and fiber 104 affixed therein—is loosely positioned inside sleeve 103 and end 104A is pigtailed (attached) to the modulator 95 or other optical circuit in housing 100. End 104A extends through aperture 101 formed in the wall of housing 100.

Solder 109 is then utilized to secure member 105A to surface 123 of sleeve 103.

If desired, stainless steel can be utilized to fabricate member 105A instead of fused silica or quartz.

One advantage of utilizing frit 111 instead of the fused silica or quartz member 105 to bond to fiber 104 is the lower temperature required to bond the frit 111 to fiber 104.

Having described my invention in such terms as to enable those of skill in the art to make and practice it, and having described the presently preferred embodiments thereof, I Claim: pg,14

1. A method for installing an optical fiber in an aperture formed through the wall of a housing for an optical circuit, the optical fiber having a selected coefficient of thermal expansion and melting point, said method comprising the steps of
(a) positioning a portion of the optical fiber in a mounting member, said mounting member having a first end and a second end, said optical fiber extending outwardly from said first and second ends, said mounting member having a melting point and coefficient of thermal expansion equivalent to that of the optical fiber;
(b) fusing said mounting member to said optical fiber; and,
(c) installing the mounting member in the aperture.

2. An assembly for installation in an aperture formed through the wall of a housing for an optical circuit, said assembly including
(a) an optical fiber having a selected coefficient of thermal expansion and melting point; and,
(b) a mounting member fused to said optical fiber and having a melting point and coefficient of thermal expansion equivalent to that of the optical fiber.

3. A method for preparing an assembly for installation in an aperture formed through the wall of a housing for an optical circuit, comprising the steps of
(a) applying a paste comprising of glass beads commercially referred to as frit material to an optical fiber; and,
(b) heating the paste to bond to the optical fiber.
